(19) United States
(12) Patent Application Publication
(10) Pub. No.: US 2010/0067695 A1
(43) Pub. Date: Mar. 18, 2010

(54) MESSAGE PROCESSING APPARATUS AND PROCESSING METHOD THEREOF

(76) Inventors: Yun-Wei LIAO, Taoyuan City (TW); Jacob GUO, Taichung County (TW); Chih-Hao HSU, Taipei City (TW)

Correspondence Address: BIRCH STEWART KOLASCH & BIRCH, PO BOX 747, FALLS CHURCH, VA, 22040-0747, US

(21) Appl. No.: 12/272,508

(22) Filed: Nov. 17, 2008

(30) Foreign Application Priority Data
Sep. 15, 2008 (TW) 97135354

(51) Int. Cl. H04L 9/00; G06F 15/16

(52) U.S. Cl. 380/255; 709/204

(57) ABSTRACT

A message processing method for publishing a message is provided. A first message including a message topic and a privacy level setting is received. It is determined whether the privacy level setting of the first message is erroneous according to the message topic and a privacy inherent relationship corresponding thereto. If so, the privacy level setting of the first message is corrected according to a predetermined privacy inherent policy. Thereafter, the first message is dispatched to at least one subscriber corresponding to the message topic.

### CROSS REFERENCE TO RELATED APPLICATIONS

This Application claims priority of Taiwan Patent Application No. 97135354, filed on Sep. 15, 2008, the entirety of which is incorporated by reference herein.

### BACKGROUND OF THE INVENTION

1. Field of the Invention

The disclosure relates generally to message processing apparatuses and related methods, and, more particularly to message processing apparatuses and related methods based on one-to-multi service level agreements.

2. Description of the Related Art

A Service level agreements (SLA) has been applied in conventional message publisher/subscriber (Pub/Sub) message architecture in which a message publisher may publish a message which is desired to be published to a broker first and the broker then publishes the message to a corresponding subscriber.

Under such conventional message publisher/subscriber (Pub/Sub) message architecture, however, the message publisher may not know the numbers of subscribers and who the subscriber is. Similarly, the message subscriber may not know which message publisher publishes the message. In this case, if one to one encryption is applied from one end to the other end, the message publisher and the message subscriber must only use a unique message key that is known by each other for encryption/decryption such that management for any subsequent member that would like to join or leave the message topic architecture is difficult. Meanwhile, multiple agreed message keys being used for multiple user clients, thereby complicating the agreement subscription and increasing the difficulty in controlling of the encrypted keys.

Moreover, for some messages which require to be encrypted, a decryption process is needed when receiving one of the messages and security, corresponding to the information for the message has to be re-configured after the message has been sent following each sent message. Therefore, in message chain architecture, downstream messages may not be able to inherent the relationship of the upstream messages due to modification of the message content or man-made oversight such that sensitive data (e.g. personal anamesis data) that being properly encrypted may be disclosed during the transmitting process, thus lowering the entire safety procedures for message transmission.

### BRIEF SUMMARY OF THE INVENTION

It is therefore an objective to provide message processing methods and systems for improving the entire safety for message transmission.

In an embodiment of a message processing method for publishing a message, a first message including a message topic and a privacy level setting is received. It is determined whether the privacy level setting of the first message is erroneous according to the message topic and a privacy inherent relationship corresponding thereto. If so, the privacy level setting of the first message is corrected according to a predetermined privacy inherent policy. Thereafter, the first message is dispatched to at least one subscriber corresponding to the message topic.

An embodiment of a message processing apparatus comprises a publish point, a privacy inherent policy, a privacy checker and a dispatcher. The publish point receives a first message comprising a message topic and a privacy level setting. The privacy inherent policy provides a privacy inherent relationship. The privacy checker is coupled to the publish point and the privacy inherent policy and obtains the first message from the publish point and determines whether the privacy level setting of the first message is erroneous according to the message topic and a privacy inherent relationship corresponding thereto, and if so, the privacy level setting of the first message is corrected according to a predetermined privacy inherent policy. The dispatcher is coupled to the privacy checker and dispatches the first message to at least one subscriber corresponding to the message topic.

Message processing methods and apparatuses may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a message processing system of the invention;

FIG. 2A is a schematic diagram illustrating an embodiment of a routing table of the invention;

FIG. 2B is a schematic diagram illustrating an embodiment of a message corresponding to the routing table of FIG. 2A of the invention;

FIG. 3 is a flowchart of an embodiment of a message processing method of the invention for configuring and generating reference privacy policies;

FIG. 4 is a flowchart of another embodiment of a message processing method of the invention for publishing a message;

FIG. 5 is a flowchart of yet another embodiment of a message processing method of the invention for processing a published message;

FIGS. 6A and 6B are schematic diagrams illustrating embodiments of message chains of the invention; and

FIG. 7 is a flowchart of an embodiment of a message processing method of the invention for processing a published message.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

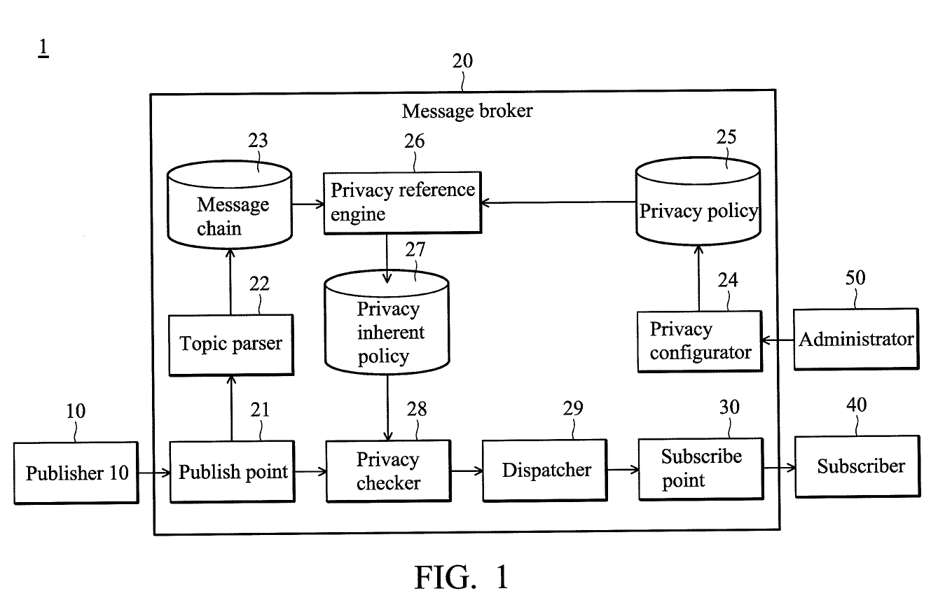

FIG. 1 is a schematic diagram illustrating an embodiment of a message processing system of the invention. The message processing system 1 at least comprises a publisher 10, a message broker 20 and a number of subscribers 40. The publisher 10 may publish a message to the subscribers 40 via the message broker 20 and the publisher 10 and the subscribers 40 may follow a specific agreement which is referred to as an SLA for message transmission. The message broker 20 comprises a publish point 21, a topic parser 22, a message chain 23, a privacy configurator 24, a privacy policy 25, a privacy reference engine 26, a privacy inherent policy 27, a privacy checker 28 and a dispatcher 29.

The publish point 21 receives a message published by the publisher 10 in which the message at least comprises a message topic and a privacy (level) setting. The privacy configurator 24 provides a user interface such that an administrator 50 may determine some message topics that need to be protected and configure privacies, keys for encryption/decryption and lawful message publishers/subscribers corresponding thereto via the user interface. The privacy policy 25 is used for storing privacy relationships corresponding to various message topics, wherein the privacy relationships at least comprise information regarding whether the message requires to be encrypted or not, key used for encryption/decryption and privacy level. The privacy inherent policy 27 provides a privacy inherent relationship. The privacy checker 28 is coupled to the publish point 21 and the privacy inherent policy 27, and the privacy checker 28 receives a first message from the publish point 21 and determines whether the privacy level setting of the first message is erroneous according to the message topic and a privacy inherent relationship corresponding thereto, and corrects the privacy level setting of the first message according to a predetermined privacy inherent policy when determining that the privacy level setting of the first message is erroneous. The predetermined privacy inherent policy will be detailed in below. The dispatcher 29 is coupled to the privacy checker 28, and dispatches the first message to multiple lawful subscribers corresponding to the message topic of the first message via the subscribe point 30.

When attempting to publish a message to the subscribers 40, the publisher 10 first publishes the message to the message broker 20 via the publish point 21. The message broker 20 then receives the message and transmits the received message to the topic parser 22 for topic parsing so as to generate a routing table based on the message topic and the routing paths for transmission. Accordingly, the routing table is used for generating a message chain 23 corresponding to the message topic.

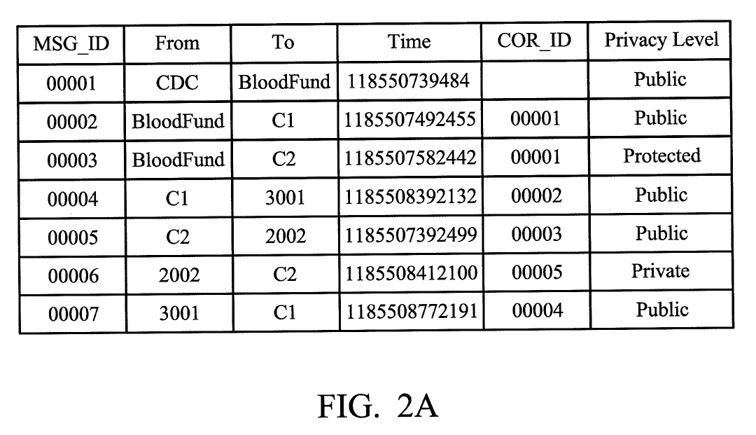

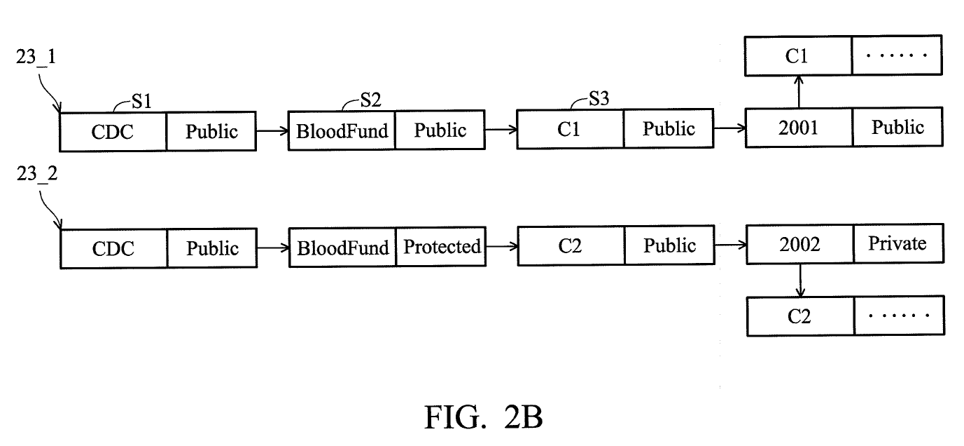

Please refer to FIG. 2A. FIG. 2A is a schematic diagram illustrating an embodiment of a routing table for generating a message chain 23. As shown in FIG. 2A, a routing table T has recorded seven message related items, and each item at least comprises an MES_ID field, a From field, a To field, a Time field, a COR_ID field and a Privacy field. The MES_ID field represent a unique device identification code for the message, the From field represents the device identification code of a device for the message source, the To field represents the device identification code of a device expected to receive the message, the Time field represents a corresponding timestamp for message transmission, the COR_ID field represents other correlation messages, indicated by MES_ID of the present message, and the Privacy field represents a privacy level or a privacy policy currently used by the present message. Therefore, the correlated messages may be combined together to generate the message chain 23 that represents a historical record of the message (as shown in FIG. 2B) when referring to the COR_ID field of the routing table T.

FIG. 21 shows message chains 23_1 and 23_2 corresponding to the routing table T. As shown in FIG. 2B, the message chain 23_1 has an order of message S1->S2->S3 in which the message S1 that is transmitted prior to the message S2 is referred to as an upstream message of the message S2 while the message S3 that is transmitted subsequent to the message S2 is referred to as a downstream message of the message S2 and so on. Thus, the historical record for message transmission may be known from the message chain and whether the privacy level setting of the transmitted message is erroneous or not may accordingly be determined by an inference calculation process.

It is to be noted that, for explanation, three privacy levels are used for configuring the privacy level in the following embodiments, but it is not limited thereto.

In this embodiment, three privacy levels that are a Public level, a Protected level and a Private Level were defined, wherein the privacy level with the Public level is larger than that with the Protected level, while the privacy level with the Protected level is larger than that with the Private level. When the privacy level of the message is configured as the Public level, no limitation is applied to the message and no key is required for encryption. When the privacy level of the message is configured as the Protected level, at least one key is required for encryption and subscribers who receive the message require the same key for decryption and may further publish the message to other subscribers. When the privacy level of the message is configured as the Private level, not only at least one key is required for encryption, but also subscribers who receive the message will be forbidden from further publishing the message to any other subscribers.

The inference policy of the privacy is defined as the privacy level of the message topic inherited by the downstream messages being less than or equal to that inherited by the upstream messages and no further message topic for downstream messages will be allowed to be appeared after the privacy level of the message has been configured as the Private level. When it is found that the privacy level of the message topic inherited by the downstream messages is larger than that inherited by the upstream messages or any further message topic for the downstream messages has appeared after the privacy level of the message has been configured as the Private level, the privacy inference policy has been violated. Therefore, the privacy level setting will be automatically corrected to a correct one according to the privacy inference policy.

For example, if a publisher A transmits a message 1 which message topic is B and a privacy level setting is configured as the Protected level to a subscriber C via the message broker 20, the subscriber C may further transmit a message 2 whose privacy level setting is configured as the Protected level or the Private level to another subscriber D due to the privacy level setting of the message 1 being configured as the Protected level. If the privacy level setting of the message 2 transmitted by the subscriber C is configured as the Private level, any transmission request issued by the subscriber D will be forbidden when the subscriber D wishes to forward another message via the message broker 20 after receiving the message 2 since the privacy inherence policy has already been violated.

The privacy reference engine 26 may perform a privacy inference calculation process to the received message for determining whether the privacy level setting of the received message is erroneous based on the message chain 23 corresponding to the message topic and a reference privacy policy 25, and if so, may correct the privacy level setting of the received message according to a predetermined privacy inference policy when any error occurs. The corrected result will be stored and utilized to generate the privacy inherent policy 27. In other words, after one message has been received, the privacy reference engine 26 may be used for calculating the privacy level and recording the calculated result as a reference data for subsequent message transmission.

In this embodiment, the administrator 50 that has an access right for managing the message broker 20 may configure a corresponding privacy level and key(s) based on the message topic and generate the reference privacy policy 25 by utilizing the privacy configurator 24.

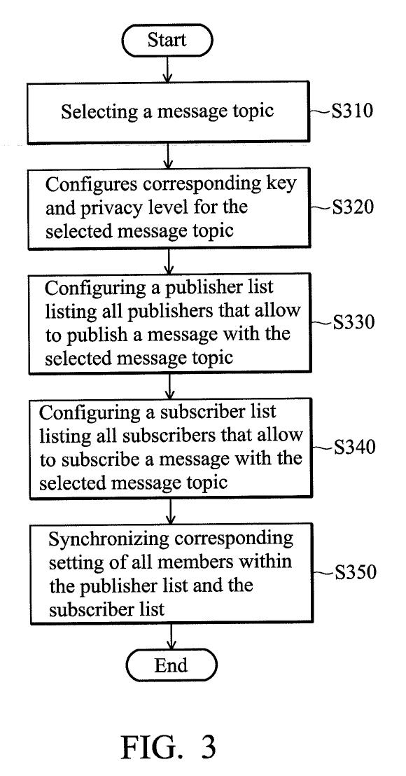

FIG. 3 is a flowchart of an embodiment of a message processing method of the invention for configuring and generating the reference privacy policy 25. First, the administrator 50 utilizes a user interface provided by the privacy configurator 24 to select a message topic (step S310) and configures a corresponding key and privacy level for the selected message topic (step S320). The administrator 50 then configures a publisher list listing all publishers that are allowed to publish a message with the selected message topic (step S330) and a subscriber list listing all subscribers that are allowed to subscribe to a message with the selected message topic (step S340). Note that only the publisher/subscriber within the publisher list/subscriber list may publish/subscribe a message with the selected message topic. Thereafter, the configuration result is sent to all members within the publisher list/subscriber list to synchronize content of the setting of the corresponding agreement thereof, such as privacy level setting for the selected message topic (step S350). Therefore, the administrator 50 may configure multiple subscribers for the same message topic and may sign a one-to-multi agreement using the message topic via the privacy configurator 24, thereby simplifying the complexity for individual agreement and the complexity for key management.

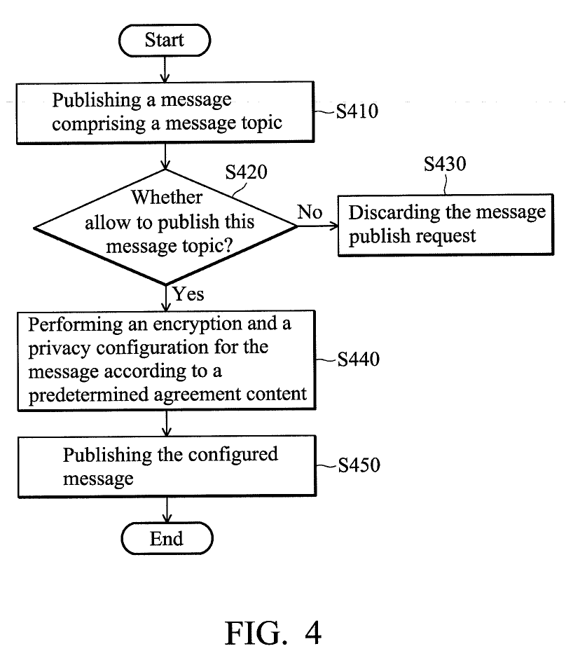

FIG. 4 is a flowchart of another embodiment of a message processing method of the invention for publishing a message. When a user of the publisher 10 attempts to publish a message comprising a message topic (step S410), it is first determined whether the publisher 10 is allowed to publish this message topic (step S420). When determining that the publisher 10 is not allowed to publish the message topic, the publish message request will be discarded (step S430). When determining that the publisher 10 is allowed to publish the message topic (Yes in step S420), the message being published is then performed an encryption (if required) and a privacy configuration according to a predetermined agreement content (step S440). For example, if it is known from the predetermined agreement content that the privacy level setting for the message topic being published may be configured as the Protected level or the Private level, a key or keys defined by the predetermined agreement will be used for encrypting the message. After the message is properly encrypted and the privacy level setting is completed, the encrypted and configured message is then published (step S450). The published message will be publish to the message broker 20 via the publish point 21.

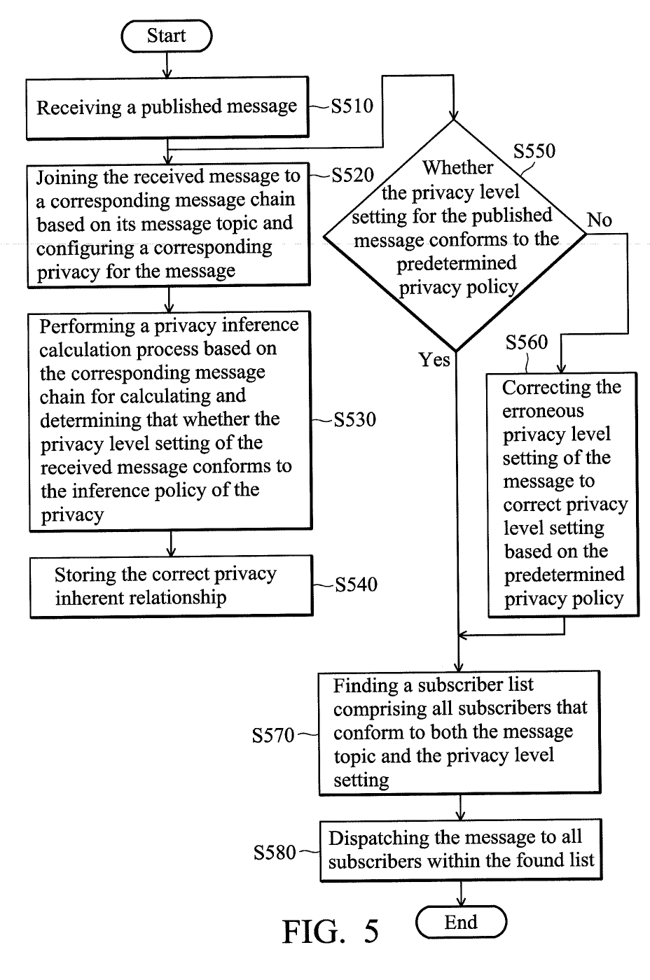

FIG. 5 is a flowchart of yet another embodiment of a message processing method of the invention for processing a published message. In step S510, after receiving the published message, the message broker 20 joins the received message to a corresponding message chain based on its message topic to generate a corresponding privacy inherent policy (e.g. steps S520-S540) on one hand, and performs a privacy determination to determine whether its privacy level setting conforms to a predetermined privacy inherent policy (e.g. steps S550-S580) on the other hand. In step S520, the received message is joined to the corresponding message chain based on its message topic. Thereafter, in step S530, a privacy inference calculation process is performed based on the corresponding message chain for calculating and determining whether the privacy level setting of the received message conforms to the inference policy of the privacy. The inference policy of the privacy is defined as the privacy level of the message topic inherited by the downstream messages being less than or equal to that inherited by the upstream messages and no further message topic for downstream messages will be allowed to be appeared after the privacy level of the message has been configured as the Private level. When it is found that the privacy level of the message topic inherited by the downstream messages is larger than that inherited by the upstream messages or any further message topic for the downstream messages has appeared after the privacy level of the message has been configured as the Private level, in step S540, the inference policy of the privacy has been violated. Therefore, the privacy level setting of the received message will be automatically corrected to a correct one according to the inference policy of the privacy.

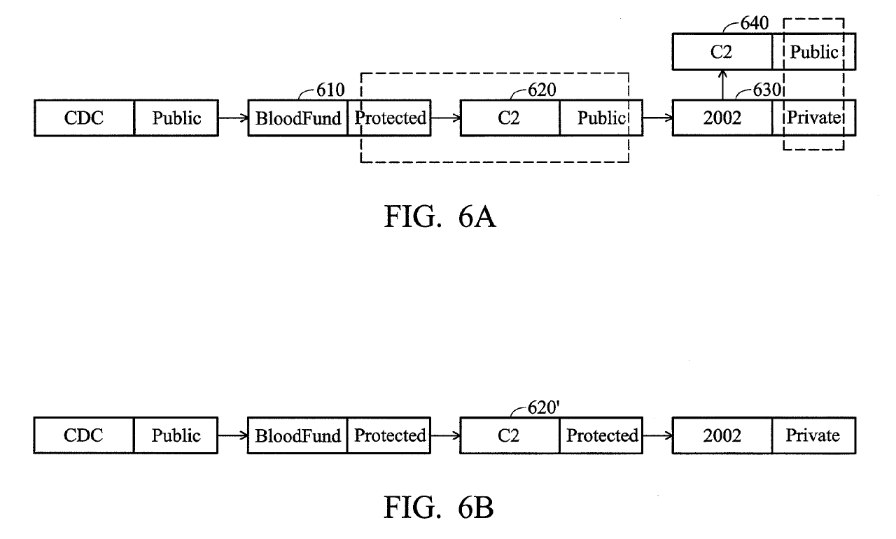

FIGS. 6A and 6B are schematic diagrams which separately illustrate an erroneous message chain and a corrected message chain. As shown in FIG. 6A, the privacy level setting of the message 610 is configured as the Protected level, but that of its downstream message 620 is configured as the Public level (i.e. larger than the Protected level), which indicates that the inference policy of the privacy has been violated. It represents that the privacy level setting of the message 620 may be erroneous or be destroyed. Similarly, the privacy level setting of the message 630 is configured as the Private level, but there still appears a downstream message 640 in the message chain, which indicates that the inference policy of the privacy has also been violated. When the privacy level setting of the received message violates the inference policy of the privacy, which indicates its privacy level setting is erroneous or has been tampered by unauthorized users, the privacy level setting of the message 620 is corrected to the Protected level (as shown in step S620′ of FIG. 6B) and the message 640 which is not allowed to be appeared will be deleted (as shown in step S640′ of FIG. 6B) based on the inference policy of the privacy. Thus, a corrected message chain will be generated so as to obtain the privacy inherent relationship as shown in FIG. 6B. At last, the privacy inherent relationship that is correct is stored (step S540) to perform the privacy determination for the downstream messages (i.e. subsequent transmitted message).

Since operations of searching the message chain and privacy inference calculation may require a longer period of time, a pre-stored correct privacy inherent relationship that is a privacy inference result from the previous or several previous times prior to the current ones may be utilized to determine whether the privacy level setting of the message is correct. In step S550, it is determined whether the privacy level setting for the published message conforms to the predetermined privacy policy. When determining that the privacy level setting for the published message does not conform to the predetermined privacy policy (No in Step S550), in step S560, the erroneous privacy level setting of the message is corrected to correct privacy level setting based on the predetermined privacy policy. When determining that the privacy level setting for the published message conforms to the predetermined privacy policy or correction of the message has been done, in step S570, a subscriber list comprising all subscribers that conform to both the message topic and the privacy level setting will be found. Thereafter, in step S580, the message will be dispatched/transmitted to all subscribers within the found list. Thus, with the privacy level configuration and the privacy inherent relationship from upstream messages to downstream messages, the privacy for the upstream messages can be inherited and wrong privacy setting occurring in the downstream messages can be found and corrected, improving the safety for message transmission.

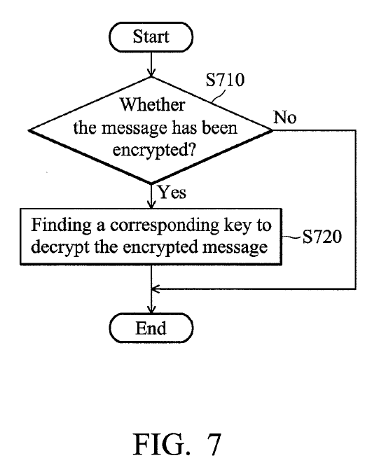

FIG. 7 is a flowchart of an embodiment of a message processing method of the invention for processing a published message. In step S710, it is checked whether the message has been encrypted. If not, the content of the message may be directly obtained and no more operations are required; if so, in step S720, a corresponding key will be found to decrypt the encrypted message so as to obtain the content of the message.

An embodiment is used below to explain the detailed process of the message processing method of the invention. In this embodiment, the message processing system is set to be a blood exchange platform and the first publisher is the local public health bureau that publishes a first message with a message topic which is not allowed to be public (such as a message topic titled “Problematic Blood bag”) and a privacy level configured as the Protected level to the blood foundation via the message broker 20. Therefore, the message broker 20 stores the privacy level setting of the first message as the privacy inherent relationship. When the first message is received by the blood foundation, it further publishes the first message to downstream corresponding blood donation centers. During message transmission, however, due to man-made oversight or network problems, the privacy level setting of the first message is changed from the Protected level to the Public level such that the original first message that had been encrypted becomes public. When receiving the message published or sent by the blood foundation, the message broker 20 checks the privacy level setting of the received message via the privacy checker 28 and discovers that the current privacy level setting (i.e. the Public level) is larger than the privacy level within the privacy inherent relationship (i.e. the Protected level). In this case, the message broker 20 determines that the inference policy of the privacy has been violated (since the privacy level of the message topic inherited by the downstream messages should be less than or equal to that inherited by the upstream messages), which indicates that error has occurred during the message transmission. Therefore, the privacy level setting of the published message will be automatically corrected to the Protected level based on the privacy inherent policy to conform with the privacy inherent policy. Since the privacy level setting of the published message is corrected to the Protected level, the published message will be again protected and encrypted. Finally, the message broker 20 dispatches the encrypted and corrected message to the corresponding blood donation centers for further processing.

In summary, according to the message processing method of the invention, by using the message privacy inference method in the message chain, message dispatching security for the publish/subscriber model can be enhanced. Furthermore, the administrator may configure various privacy policies to different message topics via the privacy configurator so as to reduce the amount of keys used and to simplify key management. When a message is received or arrived, the message broker utilizes the privacy reference engine to calculate the message privacy for the message and generates a history of the message for subsequent message publishing, checks whether the privacy of the message being transmitted conforms to the predetermined privacy policy before forwarding the message and automatically corrects the error and then dispatches the corrected message to lawful subscribers if any error occurs. By doing so, protection for sensitive encrypted data in the message can be properly ensured, providing higher safety for message publishing.

Message processing apparatuses and message processing method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A message processing method for publishing a message, comprising:
receiving a first message comprising a message topic and a privacy level setting;
determining whether the privacy level setting of the first message is erroneous according to the message topic and a privacy inherent relationship corresponding thereto;
when determining that the privacy level setting of the first message is erroneous, correcting the privacy level setting of the first message according to a predetermined privacy inherent policy; and
dispatching the first message to at least one subscriber corresponding to the message topic.

2. The message processing method of claim 1, wherein the privacy inherent relationship is obtained by using a message chain and the message chain is obtained by collecting at least one second message that is received prior to the first message, the second message comprising the message topic and a privacy level setting.

3. The message processing method of claim 2, wherein the predetermined privacy inherent policy is defined as the privacy level of the first message being less than or equal to the privacy level of the second message.

4. The message processing method of claim 3, further comprising:
when the privacy level of the first message is larger than the privacy level of the second message, determining whether the privacy level setting of the first message is erroneous, and if so, automatically correcting the privacy level of the first message to less than or equal to the privacy level of the second message.

5. The message processing method of claim 3, wherein the first message further uses a key for encryption when the privacy level of the first message is a first privacy level or a second privacy level that is less than the first privacy level.

6. The message processing method of claim 5, further comprising:
using the key for decryption to obtain the first message after the subscriber receives the encrypted first message.

7. The message processing method of claim 6, further comprising forbidding the first message from being further published when the privacy level of the first message is the second privacy level.

8. The message processing method of claim 2, further comprising:
providing a configurator for configuring a reference privacy level and the subscriber corresponding to the message topic.

9. The message processing method of claim 8, further comprising:
obtaining the privacy inherent relationship according to the message chain and the reference privacy level.

10. A message processing apparatus, comprising:
a publish point, receiving a first message comprising a message topic and a privacy level setting;
a privacy inherent policy, providing a privacy inherent relationship;
a privacy checker coupled to the publish point and the privacy inherent policy, obtaining the first message from the publish point and determining whether the privacy level setting of the first message is erroneous according to the message topic and a privacy inherent relationship corresponding thereto, and if so, correcting the privacy level setting of the first message according to a predetermined privacy inherent policy; and
a dispatcher coupled to the privacy checker, dispatching the first message to at least one subscriber corresponding to the message topic.

11. The message processing apparatus of claim 10, further comprising:
a privacy configurator, configuring a reference privacy level and the subscriber corresponding to the message topic; and
a privacy policy coupled to the privacy configurator, storing the configured reference privacy level and the subscriber corresponding to the message topic.

12. The message processing apparatus of claim 11, further comprising a privacy reference engine coupled to the privacy policy and the privacy inherent policy for performing a privacy inference process according to the a message chain corresponding to the message topic and the reference privacy level, storing the inference result and generating the privacy inherent relationship.

13. The message processing apparatus of claim 10, wherein the message chain is obtained by collecting at least one second message that is received prior to the first message, the second message comprising the message topic and a privacy level setting.

14. The message processing apparatus of claim 13, wherein the predetermined privacy inherent policy is defined as the privacy level of the first message being less than or equal to the privacy level of the second message, and when the privacy level of the first message is larger than the privacy level of the second message, the privacy checker determines that the privacy level setting of the first message is erroneous, and if so, automatically corrects the privacy level of the first message to less than or equal to the privacy level of the second message.

15. The message processing apparatus of claim 12, wherein the first message further uses a key for encryption when the privacy level of the first message is a first privacy level or a second privacy level that is less than the first privacy level.

16. The message processing apparatus of claim 15, wherein the subscriber further uses the key for decryption to obtain the first message after the encrypted first message has been received.

17. The message processing apparatus of claim 16, wherein the predetermined privacy inherent policy further comprises forbidding the first message from being further published when the privacy level of the first message is the second privacy level and automatically deleting a third message that is received subsequent to the first message when the third message has been received and the privacy checker determines that the privacy level setting of the first message is erroneous.

18. A machine-readable storage medium comprising a computer program, which, when executed, causes an apparatus to perform a message processing method, comprising:
obtaining a first message comprising a message topic and a privacy level setting;
determining whether the privacy level setting of the first message is erroneous according to the message topic and a privacy inherent relationship corresponding thereto;
when determining that the privacy level setting of the first message is erroneous, correcting the privacy level setting of the first message according to a predetermined privacy inherent policy; and
dispatching the first message to at least one subscriber corresponding to the message topic.

19. The machine-readable storage medium of claim 18, wherein the privacy inherent relationship is obtained by using a message chain and the message chain is obtained by collecting at least one second message that is received prior to the first message, wherein the second message comprises the message topic and a privacy level setting and the predetermined privacy inherent policy is defined as the privacy level of the first message being less than or equal to the privacy level of the second message.

20. The machine-readable storage medium of claim 19, wherein the message processing method further comprises:
when the privacy level of the first message is larger than the privacy level of the second message, determining whether the privacy level setting of the first message is erroneous, and if so, automatically correcting the privacy level of the first message to less than or equal to the privacy level of the second message.

21. The machine-readable storage medium of claim 18, wherein when the privacy level of the first message is a first privacy level or a second privacy level that is less than the first privacy level, the predetermined privacy inherent policy further comprises forbidding the first message from being further published when the privacy level of the first message is the second privacy level.

22. The message processing apparatus of claim 21, wherein the message processing method further comprises:
automatically deleting a third message that is received subsequent to the first message when receiving the third message and determining whether the privacy level setting of the first message is erroneous.
